(19) United States
(12) Patent Application Publication
(10) Pub. No.: US 2022/0345157 A1
(43) Pub. Date: Oct. 27, 2022

(54) MULTIBYTE ERROR DETECTION

(71) Applicant: Infineon Technologies AG, Neubiberg (DE)

(72) Inventors: Thomas Kern, Aschheim (DE); Michael Goessel, Mahlow (DE); Alexander Klockmann, Potsdam (DE); Thomas Rabenalt, Unterhaching (DE)

(21) Appl. No.: 17/719,648

(22) Filed: Apr. 13, 2022

(30) Foreign Application Priority Data
Apr. 14, 2021 (DE) 10 2021 109 391.0

(51) Int. Cl. H03M 13/15

(52) U.S. Cl. CPC H03M 13/152; H03M 13/1515

(57) ABSTRACT

A solution for detecting a multibyte error in a code word of a shortened error code is proposed, the shortened error code is a τ-byte-correcting error code, wherein bytes of the code word of the shortened error code determined a first range, the non-correctable multibyte error is detected if at least one of the following conditions is met: (a) at least one error position signal does not lie in the first range; (b) at least one error position signal indicates at least one error but fewer than terrors in the first range and no 1-byte error to (τ−1)-byte error is present.

### REFERENCE TO RELATED APPLICATIONS

This application claims priority to German Application number 10 2021 109 391.0, filed on Apr. 14, 2021. The contents of the above-referenced Patent Application is herby incorporated by reference in its entirety.

### FIELD

An error code here is either an error-correcting code, an error-detecting code or a combination of an error-detecting and error-correcting code.

### BACKGROUND

One example of an error code is the Bose-Chaudhuri-Hocquenghem code.

In the case of a BCH code, its bit-error positions to be corrected can be determined as zeros of a locator polynomial of the BCH code. In this regard, a specific procedure for a 2-bit error correction in a Galois field GF(2^{m}) using a BCH code proceeds from a corresponding second-degree locator polynomial, this polynomial is transformed such that the zeros of the transformed polynomial are determinable by means of a parameter of the word width m. This parameter is determined from the syndrome components. After the zeros of the transformed polynomial have been determined, they are to be transformed into the zeros of the original locator polynomial. Using a decoder, the bit positions to be corrected can be calculated from the zeros of the original locator polynomial.

Moreover, the error correction of 3-bit errors and 4-bit errors using BCH codes and the correction of byte errors can also use a corresponding Reed-Solomon code.

One object consists in improving the known solutions and in particular providing an approach for efficiently detecting non-correctable multibyte errors.

This object is achieved in accordance with the features of the independent claims. Preferred embodiments can be gathered from the dependent claims, in particular.

A method is proposed for detecting a multibyte error in a code word of a shortened error code,
wherein the shortened error code is a τ-byte-correcting error code,
wherein bytes of the code word of the shortened error code determine a first range,
wherein the non-correctable multibyte error is detected if at least one of the following conditions is met:
   (a) at least one error position signal does not lie in the first range,
   (b) at least one error position signal indicates at least one error but fewer than τ errors in the first range and no 1-byte error to (τ-1)-byte error is present.

In this case, it should be noted that each byte can comprise a number of b bit(s) where b≥1. The value for τ can be an integer greater than 1.

If t byte errors are detected and τ error position signals lie in the first range, then a τ-byte error can be corrected.

If no error position signal is determined, no detectable error is present.

In case (b) the at least one error position signal can lie partly or completely in the first range or not in the first range.

The error position signal, if it does not lie in the first range, can lie in a defined or a non-defined range. A non-defined range can be determined by the fact that the determination of the error position signal yields no or no valid solution.

In one development, the condition (a) furthermore comprises: the at least one error position signal which does not lie in the first range lies in a second range determined by bytes of a non-shortened error code which are not also bytes of the shortened error code.

In one development, a number of the at least one error position signal is determined by means of counting.

In one development, a byte of a code word is referenced by means of the error position signal.

In one development, the at least one error position signal is determined by means of at least one locator polynomial of the error code.

In one development, the shortened error code is a BCH code of length n over a Galois field GF (2^{m}) where n<2^{m}−1 and m≥3 holds true.

The shortened error code is determinable by shortening from a BCH code over GF(2^{m}) in each case of the length 2^{m}−1. The shortened error code is for example a τ-byte-error-correcting BCH code where τ≥2. Preferably, the shortened error code is able to detect more than τ byte errors.

In one development, the shortened error code is a Reed-Solomon code over a Galois field GF(2^{m}).

Moreover, a device is proposed for detecting a multibyte error in a code word of a shortened error code,
wherein the shortened error code is a τ-byte-correcting error code,
wherein bytes of the code word of the shortened error code determine a first range,
wherein the device is configured for detecting the non-correctable multibyte error if at least one of the following conditions is met:
   (a) at least one error position signal does not lie in the first range,
   (b) at least one error position signal indicates at least one error but fewer than τ errors in the first range and no 1-byte error to (τ−1)-byte error is present.

In one development, the device is part of a memory or of a memory system or is embodied separately from the memory or the memory system.

The device can be part of the memory or can be embodied separately therefrom. In particular, the device can comprise a processing unit that carries out the steps mentioned here. The processing unit can comprise at least one of the following components: a processor, a microcontroller, a circuit, an ASIC, an FPGA, a logic unit. The processing unit can be realized in the form of at least one physical unit. In particular, the processing unit can be distributed among a plurality of physical units.

The above explanations concerning the methods apply, mutatis mutandis, to the device. The steps of the method described here can be carried out by means of the device.

The above-described properties, features and advantages of this disclosure and the way in which they are achieved are described below in association with a schematic description of exemplary embodiments which are explained in greater detail in association with the drawings. In this case, for the sake of clarity, identical or identically acting elements may be provided with identical reference signs.

### BRIEF DESCRIPTION OF DRAWINGS

FIG. 1 shows a block diagram for elucidating steps for determining error position signals;

FIG. 2 shows a specific configuration of FIG. 1 for detecting a non-correctable multibyte error;

FIG. 3 shows an alternative configuration for the unit for determining the error position signals by way of example for a binary BCH code where b=1 or a Reed-Solomon code where b>1;

FIG. 4 shows an H² matrix of the non-shortened error code C²;

FIG. 5 shows the H¹ matrix of the shortened error code C¹;

FIG. 6 shows a table with elements of the Galois field GF(2⁵) generated by the modular polynomial p(x)=1+x²+x⁵ in a power representation, polynomial representation and tuple representation;

FIG. 7 shows an exemplary flow diagram for determining whether a non-correctable multibyte error is present.

### DETAILED DESCRIPTION

Errors in single bits or in a plurality of bits can be detected and/or corrected by means of error codes. In this case, bits can be combined or grouped in so-called bytes. A byte thus comprises a number of b bits, where b≥1 holds true.

An error code is a code which can detect and/or correct at least one error. An error code is thus an error-detecting and/or error correcting code. By way of example, the error code can be
a τ-byte-error-correcting code,
a τ-byte-error-correcting and (τ+1)-byte-error detecting code, or
a τ-byte-error-correcting and a more than τ-byte-error-detecting code.

It is advantageously the case that t≥1. As explained in the introduction, the byte comprises at least one bit. If the byte comprises exactly one bit (b=1), the error code is also referred to as a τ-bit-error-correcting and (τ+1)-bit-error-detecting code.

Bit errors can occur during the transmission of data or during the storage of data and are intended to be detected and/or corrected. By way of example, payload data can be supplemented by check data (also referred to as check bits or check bytes). The combination of payload data and check data in the error-free case advantageously yields a code word of the error code. The error code generally comprises a multiplicity of code words, e.g. of valid allocations which indicate no error from the point of view of the error code. For the sake of completeness, it should be mentioned that multiple errors can also convert one code word into another code word. In such a case, no detectable error is present, even though multiple errors actually occurred. In other words, the code word is always a valid allocation of bits, such that the error code detects no error or no error was present.

Insofar as explanations below take account of bytes, it holds true that each of the bytes has a number of b≥1 bits. Accordingly, for the case b=1, it holds true that each of the bytes comprises only exactly one bit. In this respect, e.g. the terms “bytes” or “byte sequence” could then be replaced by “bits” or “bit sequence”.

In the context of error correction a general motivation is to detect and/or correct a predefined number of errors in the bytes of a byte sequence. In this case, the bytes to be corrected can be all bytes or a subset of the bytes. One option is for check bytes, if present, not to be corrected. Furthermore, one option is for subsets of the byte sequence to be treated differently: it would thus be possible to correct errors in a first subset of the byte sequence and only to detect errors in a second subset of the byte sequence.

In order to correct an erroneous byte, it is necessary to detect the position of the erroneous byte and to determine a correction value for this erroneous byte.

If a τ-byte-error-correcting error code is considered, the following holds true for a number of 1 to τ erroneous bytes:

The position of an erroneous byte is determined by an error position signal, which assumes a first value if the corresponding byte is erroneous, and assumes a second value if the corresponding byte is not erroneous. The first value is intended to be 1, for example and the second value is intended to be 0, for example. The value by which an erroneous byte is intended to be corrected can be determined by a b-digit correction value. If the correction value is added to the erroneous byte component-by-component modulo 2, the corrected value follows therefrom.

For b=1, a b-bit byte (e.g. a byte having a number of b bits) has only a single bit and an error corrupts a bit sequence

y=y₀, . . . , yₙ₋₁

into an erroneous bit sequence

This error can be determined by means of a binary error vector

y′=y′₀, . . . , y′ₙ₋₁.

The following thus holds true:

e=e₀, . . . , eₙ₋₁.

In this case, “+” denotes addition modulo 2.

If eᵢ=1 for i∈{0, . . . , n−1}, then

y′ᵢ=yᵢ+eᵢ=yᵢ+1=y̅ᵢ

and an error is present at the bit position i, e.g. an error position signal at the position i has the value 1: bfpᵢ=1.

If eᵢ=0 for i∈{0, . . . ,n−1}, then

y′ᵢ=yᵢ+eᵢ=yᵢ+O=yᵢ

and no error is present at the bit position i, e.g. the error position signal at the position i has the value 0: bfpᵢ=0.

In the case b=1, the components of the error vector e are equal to the error position signals

bfp₀, . . . , bfpₙ₋₁.

Instead of the equation (1), the following thus also holds true for the erroneous value y′:

y′=y′₀, . . . , y′ₙ₋₁=y₀+bfp₀, . . . , yₙ₋₁+bfpₙ₋₁=y+bfp, (2)

where

bfp=bfp₀, . . . , bfpₙ₋₁

denotes an error position signal vector.

If the byte comprises more than one bit (e.g. b>1), then an i-th byte is designated by Yᵢ (or X1) and a sequence of bytes is designated by Y.

An error in the i-th byte Y′ᵢ of the byte sequence Y′=Y′₁, . . . , Y′ₙ can be described by a binary error position signal bfpᵢ=1 and an error value Eᵢ. In this case, the error value Eᵢ is a b-bit byte.

The error position signal bfpᵢ is equal to 1 if the following holds true:

$${E}_{i} \neq {\underbrace{0 , … , 0}}_{b} = \underline{0} .$$

Accordingly, the error position signal bfpᵢ is equal to 0 if the following holds true:

Eᵢ=o.

For a correctable error, the number of ones in the error position signal vector bfp is equal to the number of erroneous bytes in the byte sequence Y′=Y′₀, . . . , Y′ₙ₋₁. The byte sequence can be corrected by means of the error code, for example.

For b>1, an error vector E=E₀, . . . , Eₙ−1 consists of a number n of b-bit bytes, such that the following holds true:

Y′=Y′₀, . . . , Y′ₙ₋₁=Y₀+E₀, . . . , Yₙ₋₁+Eₙ₋₁=Y+E (3)

In equation (3), the operation “+” corresponds to component-by-component addition modulo 2.

The following thus holds true:
If Eᵢ≠0 for i∉{0, . . . , n−1}, then bfpᵢ=1 and an error is present at the i-th byte position.
If Eᵢ=0, then bfpᵢ=0 and no error is present at the i-th byte position.

The approach described herein makes it possible to determine a non-correctable error having more than ti erroneous bytes on the basis of the number of error position signals using an only t-byte-error-correcting error code.

The number of errors, the binary values of the error position signals and, if b>1, the b-bit-wide error values are determined for linear error codes, for example, by means of an error syndrome of the linear error code.

By way of example, shortened error codes are considered in the solutions described here. A shortened error code can be determined from a non-shortened error code having a longer length or code words with a longer length than the shortened error code.

By way of example, the shortened error code and the non-shortened error code can have the same number of check bits. For example, both the shortened error code and the non-shortened error code can be a τ-byte-error-correcting error code.

The shortened error code can arise from the non-shortened error code by the non-shortened error code being shortened by at least one b-bit byte.

If b=1 holds true, then each b-bit byte corresponds to exactly one bit. In this case, the error position signals identify individual bits, e.g. individual positions of a code word of the error code which are possibly erroneous.

If a τ-byte-error-correcting error code is used, in the case where there are τ errors in the b-bit bytes to be corrected, τ error position signals for the bytes of the error code that are to be corrected are determined as one by means of the resulting error syndrome. The remaining error position signals are equal to 0.

A non-correctable multibyte error having more than τ erroneous bytes can be detected from the fact that fewer than τ error position signals for the bytes to be corrected assume the value 1 and if
no 1-byte error,
no (τ−1)-byte error
occurs.

If one of the τ error position signals which assume the value 1 for a byte position is determined during the error correction by which the non-shortened error code was shortened during the determination of the shortened error code, it can be detected from this that fewer than τ error position signals for the bytes of the shortened error code are determined as 1.

The byte positions of the shortened error code that are to be corrected are referred to as value range of the error position signals. In the case of a 1-byte error, 2-byte error to τ-byte error in the bytes of the shortened error code, the error position signals which assume the value 1 are then all elements of this value range of the error position signals.

By contrast, if an error position signal, which is not an element of the value range of the error position signals, is determined as 1, a non-correctable error is present.

If it is additionally determined that no 1-byte error, etc. to (τ−1)-byte error of the bytes to be corrected is present, or if an error position signal having the value 1 is determined which lies outside the value range of the error position signals, at most (τ−1), error position signals which assume the value 1 can be elements of the value range of the error position signals. The presence of the error signal, which assumes the value 1 and is not an element of the value range of the error position signals, already indicates that a non-correctable error is present. In this case, it is not necessary to determine the number of error position signals having the value 1, which lie in the value range of the error position signals, which assume the value 1.

### EXAMPLE

By way of example, a τ-byte-correcting error code shall serve as error code. This error code can thus correct a maximum of τ erroneous bytes and thus a maximum of τ error position signals can be equal to 1.

Said τ-byte-correcting error code is for example a shortened error code. It arose as a result of shortening of Kbytes

Byte₀, Byte₁, . . . , Byte_{K-1}

from a likewise τ-byte-correcting non-shortened error code.

In the case of an error in more than τ bytes of the shortened error code, an error syndrome can be determined for example such that it is identical to an error syndrome of a byte error of the non-shortened error code, the error occurring in a shortened byte. This therefore results in an error position signal at a position which does not exist in the shortened error code: the error position signal points to a shortened byte which is not part of a code word of the shortened error code. Therefore, at most (τ−1) error position signals (having a value 1) can reference bytes of the shortened error code. Consequently, there remain fewer than τ error position signals for the bytes of the shortened error code, which can still assume the value 1.

If it is known that during the error correction τ error position signals which assume the value 1 are determined for example on the basis of the error syndrome, an error position signal with the value 1 being determined for a byte that is a byte of the unshortened error code and is not a byte of the shortened error code, then a non-correctable error is present. This can be detected for example from the fact that the number of error position signals which assume the value 1 is less than τ for the bytes of the shortened error code. That can likewise be detected from the fact that an error position signal is determined for a byte of the unshortened error code that is not a byte of the shortened error code.

If it is determined that no 1-byte error to no (τ−1)-byte error is present and if the error code is a τ-byte-error-correcting error code, a non-correctable error can be detected from the fact that fewer than τ error position signals having the value 1 are determined for the bytes of the error code that are to be corrected.

Using the number of error position signals for bytes of the shortened error code which assume the value 1 during an error correction, a non-correctable error can thus be detected.

In this regard, it is possible, using the number of error position signals which have the value 1 and thus indicate an error of the byte corresponding to them for the bytes of a code word of the shortened error code, to detect a non-correctable error without further check bytes being required.

It is not necessary to determine the exact number of error position signals which assume the value 1 for the bytes to be corrected. It can be sufficient to determine that their number is less than τ or not equal to τ if the shortened error code is a τ-byte-error-correcting error code, for example, and the decoding is effected such that a maximum of τ error position signals are determinable.

Optionally, the bytes can also comprise address bits or address bytes of a read address and/or a write address or can be derived from such an address.

Furthermore, one option is that a parity of the bytes can be taken into account in order to determine whether a 1-bit error, etc. is present. A parity bit can be provided, for example, which is taken as a basis for carrying out filtering with regard to specific multibyte errors.

### Error Codes

Linear codes are considered below by way of example.

For illustration purposes, firstly the case b=1 is considered, e.g. a b-bit byte corresponds to a single bit.

A bit sequence of k bits

x=x₀, . . . , xₖ₋₁

is coded into a code word

y=y₀, . . . , yₖ₋₁

where n>k>1. It furthermore holds true that

y=x·G, (4)

where G is a (k,n) matrix, designated as generator matrix of the error code under consideration. For b=1, the elements of the generator matrix are binary. These elements of the generator matrix can also be referred to as elements of the Galois field GF(2).

The generator matrix is designated in its systematic form by

G_{sys}=(P_{k,n-k}, Iₖ) (5)

where
Iₖ denotes the k-dimensional unit matrix and
   P_{k,n-k} denotes a (k,n−k) matrix (parity matrix).

The generator matrix in systematic form in accordance with equation (5) is used to determine the H matrix in systematic form

H_{sys}=(Iₙ₋ₖ, P_{n-k,k}^{T}), (16)

In this case,

P_{n-k,k}^{T}

is the transpose matrix of

P_{k,n-k}

From a given G matrix, it is possible to derive further G matrices by linear combination of its rows. Likewise from a given H matrix, it is possible to derive further H matrices by linear combination of its rows.

The H matrix in accordance with equation (6) is determined here, like any H matrix of a code, in such a way that the following holds true for a code word of the associated error code:

H_{sys}y=0|. (7)

In this case, 0| denotes a column vector the elements of which are all zeros.

For an erroneous word

y′=y+e=y+bfp

it correspondingly holds true that

H_{sys}y′=H_{sys}(y+e)=H_{sys}·e=H_{sys}·bfp=s_{sys}≠0|, (8)

where

s_{sys}=H_{sys}·e=H_{sys}·bfp

can be designated as an error syndrome for the H_{sys} matrix.

If another H matrix is determined for example from H_{sys} by linear combination of its rows, the corresponding error syndrome is designated by

S=H·e

The minimum number of check bits of a linear error code can be determined by the rank of the H matrix of the error code.

If the H matrix of the error code is supplemented by linearly dependent rows, the number of check bytes of the error code can be greater than the rank of the H matrix.

The error syndrome determined from the erroneous word y′ can be used for error correction if, for the set of error vectors under consideration, each of these error vectors leads to a different error syndrome. The different bit positions corresponding to the error syndromes are determined during the error correction. An error position signal corresponds to each error position. If the error position signal is equal to 1, the referenced error position is erroneous.

If b=1, then a single bit is referenced by way of the error position signal. It is thus necessary to correct one bit per error position signal, and the correction value can be equal to 1 for the bit to be corrected. In this case, the error value is equal to the value of the error position signal; it is not necessary for a separate error value to be specified. For b=1, addition and multiplication of binary values take place in each case modulo 2, e.g. in the body Galois field GF(2).

For 2, a byte sequence composed of k b-bit bytes

x=x₀,x₂, . . . xₖ₋₁

is coded into a code word

Y=Y₀, . . . , Yₙ₋₁

In this case, the error position signal is a byte error position signal. For example, a byte error position signal having the value 1 indicates that the referenced byte (comprising b bits) is erroneous in at least one of its b bits. If the byte error position signal has the value 0, the referenced byte is not erroneous (or no error was detectable).

For a τ-byte-error-correcting code, it holds true that if at most τ byte errors are present: a byte error of the i-th byte can be described by a binary error position signal bfpᵢ and a byte error value Eᵢ. In this case, the byte error value Eᵢ comprises b bits.

If Eᵢ≠0 holds true for a byte error value, the error position signal bfpᵢ can be assigned to the i-th byte. If E1=0, the binary error position signal bfpᵢ=0 can be assigned to the i-th byte.

The error position signal describes whether
a determined byte position is erroneous and is (can be) corrected or
a determined byte position is not erroneous.

In this case, the error position signal does not specify a correction value for the possible erroneous byte position.

As explained, the error position signals can be combined in the error position signal vector

bfp=bfp₀, . . . , bfpₙ₋₁.

The number of error position signals which are equal to 1 describes how many of the bytes referenced by the error position signals are erroneous.

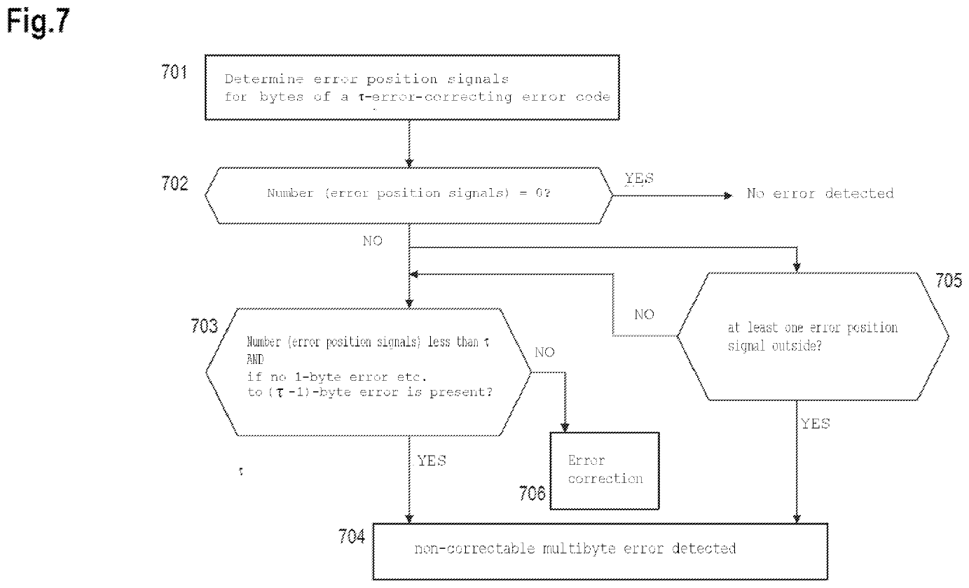

FIG. 7 shows an exemplary flow diagram for determining whether a non-correctable multibyte error is present. The order and the steps shown are merely exemplary embodiments. FIG. 7 shows the following steps and interrogations:

Step 701: error position signals are determined for bytes of a code word. In this case, a byte comprises b bit(s) where b≥1. The method branches to step 702. Alternatively, the method could branch directly from step 701 to step 705.

Step 702: This involves determining whether the number of error position signals is equal to 0. If this is the case, then no error is detected. If at least one error position signal is present, the method branches to step 703. In an alternative embodiment, the method branches to step 705.

Step 703: A check is made to ascertain whether the number of error position signals for bytes of the shortened error code is less than τ and whether no 1-byte error, . . . to no (τ−1)-byte error of the shortened error code is present. If this is not applicable, then a correctable error is present and the method branches to step 706. Otherwise, that is to say if none of these errors was detected, the method continues with step 704.

(a) The shortened error code is a τ-byte-error-correcting error code. The shortened error code is determinable from a non-shortened error code.

Step 704: A non-correctable multibyte error is detected since no correctable error could be detected.

Step 705: A check is made to ascertain whether at least one error position signal lies in a range outside a range which is determined by the bytes of the code word of the shortened code. If this is the case, the method branches to step 704. Otherwise the method branches to step 703.

Step 706: The error correction of the at most τ erroneous bytes is carried out.

The formulation “a 1-byte error, . . . to (τ−1)-byte error” indicates the error types for arbitrary values of τ. For τ=3, 1-byte-errors and 2-byte errors are thus encompassed. For τ=5, 1-byte errors, 2-byte errors, 3-byte errors and 4-byte errors are thus encompassed.

### Exemplary Determination of Multibyte Errors

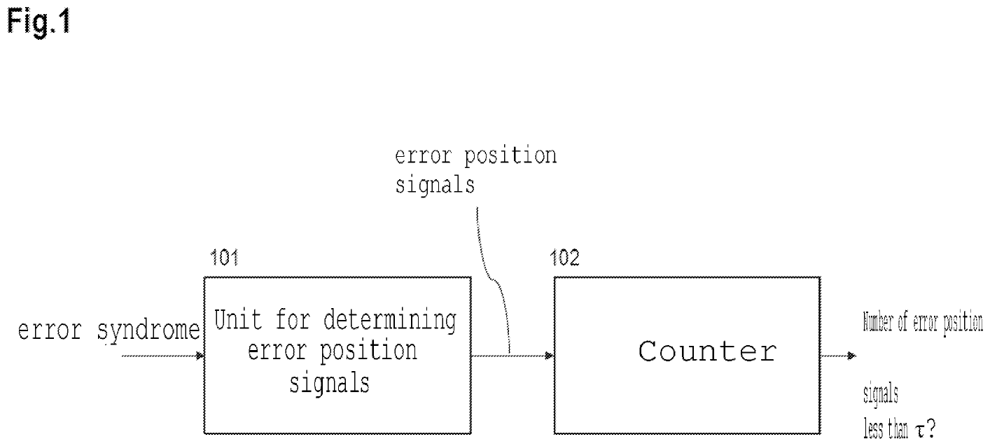

FIG. 1 shows a block diagram for elucidating steps for determining error position signals. By way of example, the decoding, error correction and error detection are effected using an error syndrome. A syndrome generator provides an error syndrome present at the input of a unit 101 for determining error position signals. The unit 101 yields error position signals bfp₀, . . . , bfpₙ₋₁ for the byte positions to be corrected. The error position signals serve as input values of a counter 102. The syndrome generator is not shown in FIG. 1.

The counter 102 ascertains whether fewer than τ or exactly τ error position signals assume the first value.

The syndrome generator, the unit 101 and also the counter 102 can be realized as hardware and/or software.

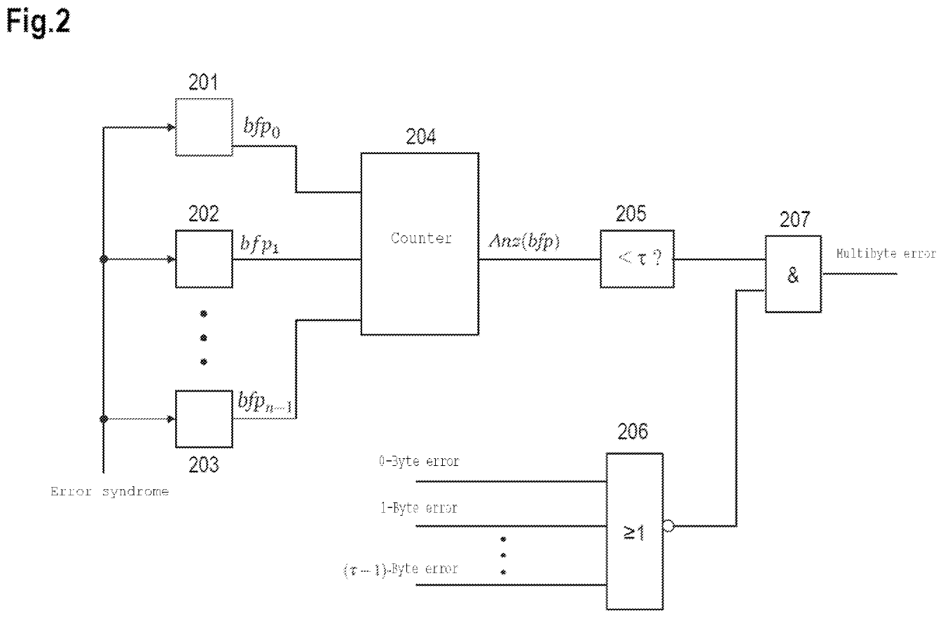

FIG. 2 shows a specific configuration of FIG. 1 and allows the detection of a non-correctable multibyte error.

In FIG. 2, the unit 101 for determining the error position signals is divided into n units 201 to 203, which each determine an individual one of the error position signals bfp₀ to bfpₙ₋₁ on the basis of the error syndrome. The error position signal is deemed to be determined if the first value is present at the output of the respective unit 201 to 203.

The outputs of the units 201 to 203 are connected to a counter 204. The counter 204 determines how many of the units 201 to 203 provide the first value, e.g. the counter 204 counts the first values provided by the units 201 to 203 (in relation to a predefined time unit).

A comparator 205 connected downstream of the counter 204 determines whether the number of error position signals determined by the counter

Anz(bfp)

is less than or equal to τ, where τ indicates the maximum number of errors correctable by the error code.

By way of example, the comparator 205 yields at its output
the value 1 if Anz(bfp)<τ and
the value 0 if Anz(bfp)=τ.

On the basis of the error code, for example using the error syndrome, error signals can be determined. The error signals
1-byte error,
2-byte error,
(τ−1)-byte error are present at the inputs of a NOR gate 206, one error signal being present per input. The value 1 is present at the output of the NOR gate 206 only if all inputs have the value 0. Accordingly, the value 1 at the output of the NOR gate 206 indicates that no error was determined on the basis of the error signals.

Furthermore, a signal zero-byte error is present at the input of the NOR gate 206 and indicates with its value 1 that no error has occurred, and indicates with its value 0 that an error has occurred. If the signal 0-byte error has the value 1, no multibyte error is detectable either.

The output of the comparator is connected to a first input of an AND gate 207 and the output of the NOR gate 206 is connected to a second input of the AND gate 207.

The output of the AND gate 207 has the value 1 only if the comparator 205 determined that fewer than τ error position signals were counted by the counter 204 and the NOR gate 206 determined that none of the errors 0-byte error to (τ−1)-byte error was present.

If no 0-byte error, etc. to no (τ−1)-byte error occurred and in addition the comparator 205 indicates, by means of the value 1 output, that Anz(bfp)<τ holds true, then the AND gate 207 outputs the value 1. This indicates a non-correctable multibyte error.

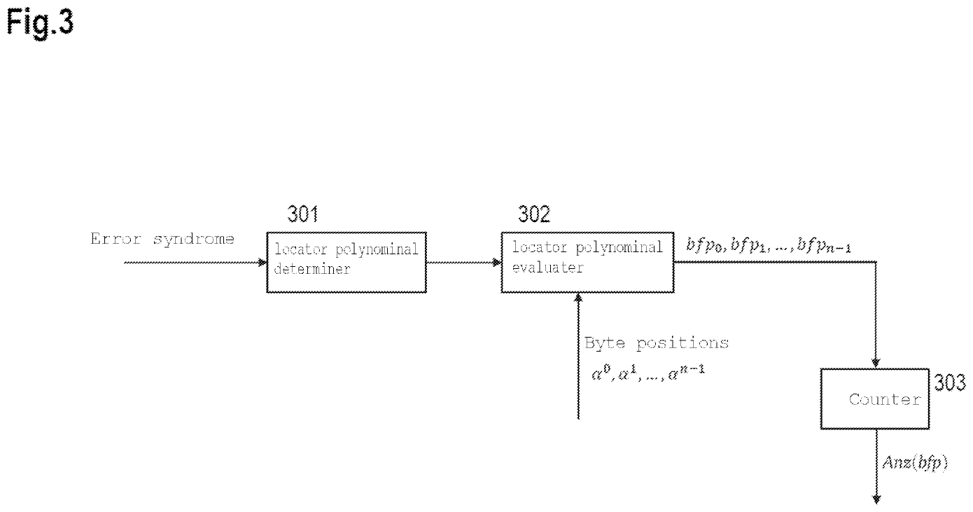

FIG. 3 shows an alternative configuration for the unit for determining the error position signals by way of example for a binary BCH code where b=1 or a Reed-Solomon code where b>1.

The error syndrome is fed to a unit 301 for determining locator polynomials. The unit 301 provides locator polynomials that are subsequently processed by a unit 302 for locator polynomial evaluation. In addition to the locator polynomials, the unit 302 also receives byte positions α⁰ to αⁿ⁻¹ and yields as a result error position signals bfpᵢ where i=1, . . . ,n−1. The error position signals are counted by a counter 303 connected downstream. The counter 303 provides a number Anz(bfp) of error position signals at its output.

In order to determine locator polynomials on the basis of the error syndrome, the Berlecam-Massey algorithm, for example, can be used.

The unit 302 for locator polynomial evaluation determines, for the byte positions α⁰ to αⁿ⁻¹ to be corrected, whether the locator polynominal for an αⁱ is equal to 01 or not equal to 01. If the locator polynominal for αⁱ is equal to 0|, then the value of the corresponding error position signal is equal to 1; if the locator polynominal for αⁱ is not equal to 0|, then the value of the corresponding error position signal is equal to 0. In order to determine the values of the locator polynominal, the Chien search algorithm can be used, for example, which determines the zeros of the locator polynominal.

The value of the error position signal bfpᵢ
1 is 1 if the locator polynominal for αⁱ assumes the value 0|, and
is 0 if the locator polynominal for αⁱ assumes a value not equal to 0|.

In this case, α⁰ to αⁿ⁻¹ are elements of a Galois field GF(2^{m}) where m>3 and a is a generating element of the Galois field.

An example where b=1 is considered below. 8 data bits are intended to be processed by means of a shortened error code C¹. The shortened error code C¹ is a shortened 3-bit-error-correcting and 4-bit-error-detecting BCH code with total parity included. The Galois field used is GF(2⁵). The 8 data bits are protected by 16 check bits. A code word of the error code C¹ thus has 8+15+1=24 bits.

A non-shortened error code C² is for example a 3-bit-error-correcting and 4-bit-error-detecting BCH code with total parity included. The error code C² has the length of 2⁵−1=31 bits.

The shortened error code C¹ arises as a result of shortening of 7 bits from the non-shortened error code C².

A code word of the non-shortened error code

y²=y₀², y₁², . . . , y₃₀²

has 31 bits and a code word of the shortened error code

y¹=y₀¹, y₁¹, . . . , y₂₃¹

has 24 bits.

The shortening of a linear code can be achieved by deleting columns of the H matrix.

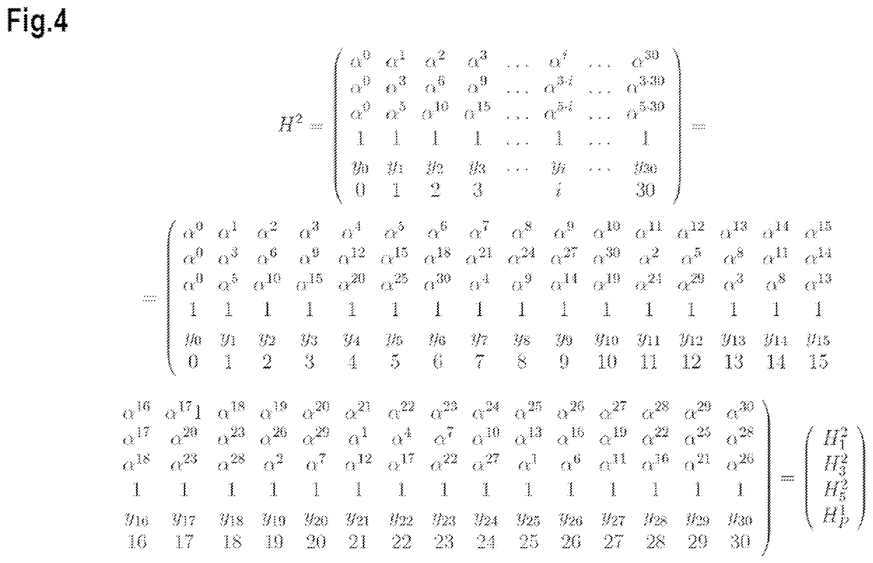

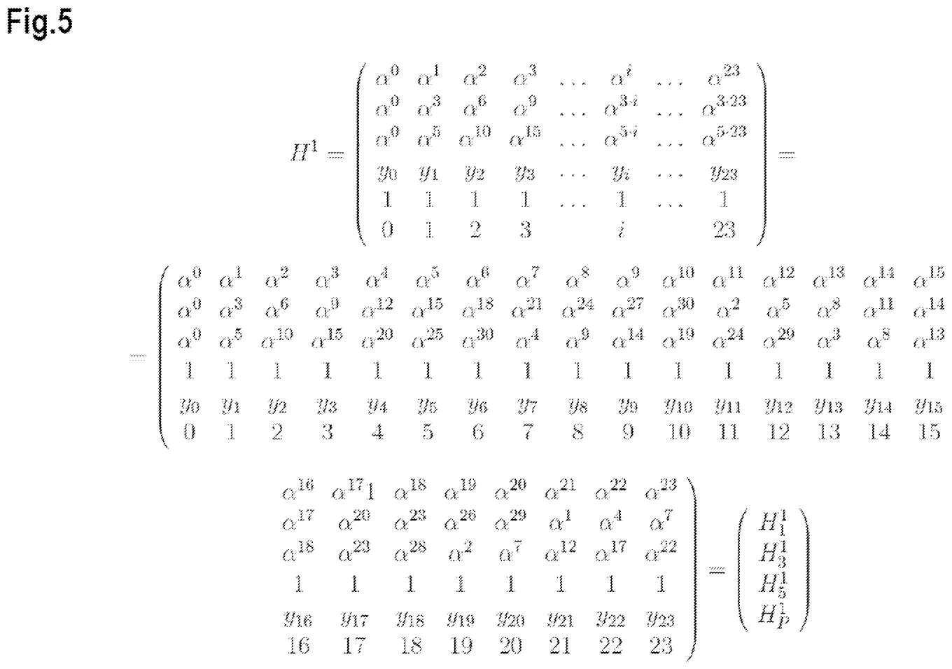

FIG. 4 shows an H² matrix of the non-shortened error code C² and FIG. 5shows the H¹ matrix of the shortened error code C¹.

The H¹ matrix of the shortened error code arises as a result of deleting the columns 30, 29, 28, 27, 26, 25, 24 from the H² matrix of the non-shortened error code. As a result, the non-shortened error code is shortened by the bits y₃₀, y₂₉, y₂₈, y₂₇, y₂₆, y₂₅, y₂₄.

The H¹ matrix of the shortened code has 24 columns, a code word of the shortened code has 24 bits. The length of the shortened code is equal to 24 in this exemplary embodiment.

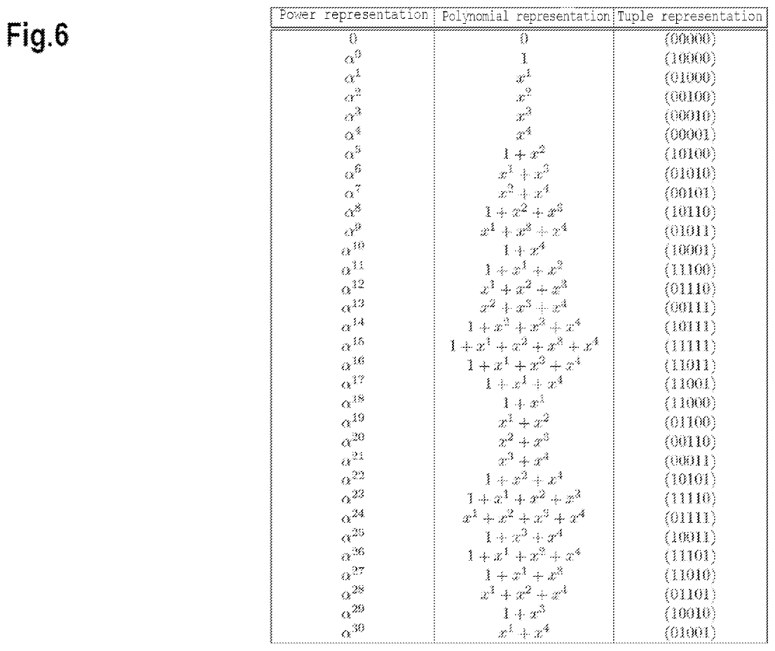

In this case, α⁰ to αⁱ are elements of the Galois field GF(2⁵). These elements can be represented differently (cf. the table shown in FIG. 6). Exponents should be interpreted modulo 2^{m}−1 for a Galois field GF(2^{m}): for the Galois field GF(2⁵) used, this corresponds to an interpretation modulo 31.

FIG. 6 shows a table with elements of the Galois field GF(2⁵) generated by the modular polynomial p(x)=1+x²+x⁵ in a power representation, polynomial representation and tuple representation (also referred to as vector representation).

For the error detection the following holds true:
for a 0-bit error (that is to say if no error is present)

s₁³=s₃=s₅=| and s_{P}−0. (9)
for a 1-bit error

s₁³=s₃≠0| and s_{P}=1, (10)
for a 2-bit error

s₁³≠s₃ and s_{P}=0 (11)
for a 3-bit error

s₁³≠s₃ and s_{P}=1. (12)

The error correction of BCH codes can be effected by means of locator polynomials.

The 3-bit error correction is described by way of example below. A 3-bit error can be determined using a third-degree locator polynomial

L(z/3)==z³(s₁³+s₃)+z²(s₁⁴+s₁s₃)+z(s₁²s₃+s₅)+s₃(s₁³+s₃)+s₁(s₁⁵+s₅) (13)

on the basis of its zeros: the three zeros of the locator polynomial in accordance with equation (13) show the error positions in the data and thus represent the error position signals.

A 3-bit error can be corrected by a procedure in which, for i where 0≤i≤23 a check is made to ascertain whether for z=αⁱ

L(αⁱ/3)=0| (14)

holds true such that for each bit position to be corrected

α³⁻ⁱ(s₁³+s₃)+α²⁻ⁱ(s₁⁴+s₁s₃)+αⁱ(s₁²s₃+s₅)+s₃(s₁³+s₃)+s₁(s₁⁵+s₅)=0| (15)

is checked. On the basis of the zeros of the locator polynomial, the bit positions to be corrected and thus the values of the error position signals for these bits are determined as 1. For all other bit positions, the values of the error position signals are equal to 0.

The locator polynominal L(z/3) here is a third-degree polynominal having at most three different zeros. In the case of a 3-bit error within the bit positions 0 to 23 the following holds true:
if the value of the locator polynominal L(z/3) for z=αⁱ is equal to 0|, an error is present at the i-th bit position and the value of the error position signal bfpᵢ is 1.
If the value of the locator polynominal L(z/3) for z=αⁱ is not equal to 0|, no error is present at the i-th bit position and the value of the error position signal bfpᵢ is 0.

### SUMMARY

These determinations can be carried out simultaneously or at least partly simultaneously. In this sense, parallel or partly parallel processing can be effected, which can advantageously shorten the required processing duration.

One option is to insert the values α⁰ to α²³ for z successively or sequentially into the locator polynominal L(z/3) and to determine whether and for which values αⁱ the locator polynominal L(z/3) assumes the value 0|. For these zeros, the value of the corresponding error position signal bfpᵢ is equal to 1. If the value of the locator polynominal is not equal to 0|, the value of the corresponding error position signal is equal to 0.

A check is then made to ascertain whether the following two conditions are met:
1. For i where 0≤i≤23, is the number of error position signals which assume the value 1 less than 3?
2. Is neither a 0-bit error, nor a 1-bit error, nor a 2-bit error present? (this can be checked on the basis of equations (9), (10) and (11).)

If these two conditions are met, there is a non-correctable error in the bits 0 to 23.

One option is to check whether for the locator polynominal

L(αⁱ)=0|

holds true for an i≥24. Since the locator polynomial has at most three different zeros, then the locator polynomial can still have at most two zeros for αⁱ where 0≤i≤23.

If it is thus detected that L(α/)=0| holds true for a j≥24, then it can be detected from this that a non-correctable error has occurred.

The length of the shortened error code is equal to 24 in this exemplary embodiment. The bits of the error code are designed as 0-th bits to 23^{rd} bit.

On the basis of the zeros of the locator polynomial L(z/3) of equation (13), which is a third-degree polynomial, it is possible to ascertain whether a correctable 3-bit error or a non-correctable multibit error is present. In this case, the coefficients of the locator polynomial are determined on the basis of the components s₁, s₃, s₅ of the error syndrome of the error that has occurred.

As a third-degree polynomial, the locator polynomial L(z/3) has the three zeros αⁱ¹, αⁱ², αⁱ³. If these three zeros correspond to bit positions of the shortened error code, then a correctable three-bit error is present. The following holds true in this case:

0≤i₁, i₂, i₃≤23.

For i₁, i₂ and i₃, the corresponding error position signals bfpᵢ₁, bfpᵢ₂, bfpᵢ₃ are in each case equal to 1 and the erroneous word of the shortened error code is corrected in the bit positions i₁, i₂ and i₃.

As stated by way of introduction above, the byte positions to be corrected or the bit positions to be corrected of the shortened error code are referred to as value range (of the error position signals). In this example, the three error position signals are then elements of this value range.

By contrast, if there is a zero α^{j} where j≥24, which in other words does not lie in the value range, there can still only be at most two error position signals which assume the value 1 and lie in the value range since a third-degree polynomial has only three zeros.

Consequently, there can be no correctable 3-bit error in the bits of the shortened error code if one of the zeros of the locator polynominal is determined for a bit position which lies outside the bit positions of the shortened code. The conclusion that can be drawn from this is that a non-correctable multibit error has occurred in the bits of the shortened error code.

In other words: a non-correctable multibit error can already be detected from the fact that a zero α^{j} with j≥24 is determinable for the third-degree locator polynominal, such that the corresponding error position signal lies outside the value range for the shortened error code.

Alternatively, a non-correctable multibit error that has occurred can also be detected from the fact that if the error positions are determined as zeros of an m-th degree locator polynominal, fewer than m error position signals are determined for the bits of the shortened error code for which the error position signals assume the value 1.

The procedure described will now be illustrated on the basis of an example.

It is assumed by way of example that a 5-bit error has occurred in the bit positions y₁₄, y₁₈, y₁₉, y₂₀, y₂₁, for which error the syndrome components s₁, s₃, s₅ and sₚ of the shortened error code are determined by the component-by-component XOR sums (exclusive-OR sums) of the corresponding columns of the H¹ matrix in accordance with FIG. 5 as

s₁=α¹⁴+α¹⁸+α¹⁹+α²⁰+α²¹=α²⁰

s₃=α¹¹+α²³+α²⁶+α²⁹+α¹=α⁷

s₅=α⁸+α²⁸+α²+α⁷+α¹²=α⁵

s_{P}=1+1+1+1+1+1=1

This can be verified using the elements of the Galois field GF(2⁵) shown in FIG. 6.

The conditions for a 3-bit error are shown by equation (12). The following hold true in the present case:

s₁³=α^{3·20}=α²⁹,

s₃=α⁶,

s₁³≠s₃,

s_{P}=1.

The conditions for a 3-bit error present would thus actually be met. This is not applicable in the present case, however, since—as mentioned—in actual fact a 5-bit error is present in this example.

The BCH error code used by way of example here is however only able to correct 3-bit errors and to detect 4-bit errors. An explanation is given below of how it is nevertheless possible to detect a (non-correctable) 5-bit error.

A 3-bit error thus initially appears to be present. However, none of the error position signals indicates an erroneous bit for the bits 0 to 23 to be corrected (the values of the error position signals are all equal to 0).

For i where 0≤i≤23, the following holds true for the locator polynomial in accordance with equation (13)

L(αⁱ/3)≠0|. (16)

This can be verified by inserting the values α⁰ to α²³. The following thus holds true for all error position signals

bfp₀=bfp₁= . . . =bfp₂₃=0.

Since fewer than three error position signals assume the value 1, it can thus be determined that a non-correctable multibit error has occurred in the bits y₀ to y₂₃ of the shortened error code.

In other words: on the one hand it is apparent from equation (13) that a 3-bit error is present, and on the other hand there is no error position signal that confirms this statement. There is therefore a contradiction between these two conditions. The conclusion that can be drawn from this is that a multibit is present. The latter is not correctable. In particular, on the basis of the information available it is not evident which bits are erroneous. Moreover, it is not known what type of multibit error (here the exemplary 5-bit error) is involved and how the multibit error should be corrected. However, it is of considerable advantage to detect that a multibit error is present. This fact can be utilized for further actions; for example, a further error correction may be necessary, a memory area can be identified as erroneous a transmission can be repeated, a component can be replaced and/or an alarm message can be output.

For the bits y₂₆, y₂₉ and y₃₀ which are bits of the non-shortened error code, but are not bits of the shortened error code, the result is

L(α²⁶/3)=L(α²⁹/3)=L(α³⁰/3)=0|. (17)

The locator polynomial according to equation (17) has three zeros α²⁶, α²⁹ and α³⁰ in this example. These correspond to bit positions of the non-shortened error code which however are not bit positions of the shortened error code.

If the value of an error position signal for a bit position of the non-shortened error code is determined as 1 and the bit position is not a bit position of the shortened error code, then it already follows from this that for the bit positions of the shortened error code fewer than i error position signals can assume the value 1 (if the shortened error code is a τ-bit-error-correcting error code).

One option is to count the values of the error position signals which assume the value 1. This can be done for example by means of a binary counter (sequentially or parallel). If the counter determines that the counter reading is less than τ if a τ-bit-error-correcting shortened error code is used, a non-correctable error can be detected if it is determined that no 1-bit error, etc. to no τ-bit error has occurred. If a τ-th degree locator polynomial is determined, it can already be determined that a non-correctable multibit error has occurred if fewer than τ error position signals for the bit positions of the shortened error code assume the value 1.

If it is ascertained that an error position signal equal to 1 is determined for an error position which does not correspond to a bit position of the shortened error code, but rather to a bit position of the non-shortened error code, a non-correctable error is detected.

In this case, the error positions can be counted using either a sequential counter or a parallel counter, where a sequential counter should be reset to its initial state after each counting process.

The values of the error position signals bfp₀ to bfp₂₃ can be determined here or at least partly in parallel. From the bit positions to be corrected, the error position signals are determined as 1.

The values of the error position signals can also be determined by means of a search method using software, wherein all elements of the Galois field which correspond to the bit positions of the shortened error code are inserted into the locator polynomial and an error position signal for the corresponding bit is determined as 1 if the locator polynomial assumes the value 0| for the inserted value.

An analogous procedure can be adopted if the shortened error code is a b-bit byte-error-correcting code where b>1 and the shortened error code is determinable from a non-shortened error code. In the case of shortening a τ-byte-error-correcting code where b>1, the shortened error code is determinable by shortening bytes of the non-shortened error code.

During the error correction it is possible to determine an error position signal which assumes the value 1 if an error occurs in the corresponding byte. The error position signal can be determined as 1 if the locator polynomial assumes the value 0|, and can be determined as 0 if the locator polynomial assumes a value not equal to 0|.

The value of the error or the error value for correcting an erroneous byte can be determined by an error polynomial, for example.

Although the disclosure has been more specifically illustrated and described in detail by means of the at least one exemplary embodiment shown, nevertheless the disclosure is not restricted thereto and other variations can be derived therefrom by the person skilled in the art, without departing from the scope of protection of the disclosure.

1. A method for detecting a non-correctable multibyte error in a code word of a shortened error code,
wherein the shortened error code is a τ-byte-correcting error code,
wherein bytes of the code word of the shortened error code determine a first range,
wherein the non-correctable multibyte error is detected if at least one of the following conditions is met:
(a) at least one error position signal does not lie in the first range,
(b) at least one error position signal indicates at least one error but fewer than terrors in the first range and no 1-byte error to (τ−1)-byte error is present.

2. The method as claimed in claim 1, wherein condition (a) furthermore comprises:
the at least one error position signal which does not lie in the first range lies in a second range determined by bytes of a non-shortened error code which are not also bytes of the shortened error code.

3. The method as claimed in claim 1, wherein a number of the at least one error position signal is determined by counting.

4. The method as claimed in claim 1, wherein a byte of the code word is referenced by the error position signal.

5. The method as claimed in claim 1, wherein the at least one error position signal is determined by at least one locator polynomial of the shortened error code.

6. The method as claimed inclaim 1, wherein the shortened error code is a Bose-Chaudhuri-Hocquenghem code of length n over a Galois field GF (2^{m}) where n<2^{m}−1 and m≤3 holds true.

7. The method as claimed in claim 1, wherein the shortened error code is a Reed-Solomon code over a Galois field GF (2^{m}).

8. A device for detecting a multibyte error in a code word of a shortened error code,
wherein the shortened error code is a τ-byte-correcting error code,
wherein bytes of the code word of the shortened error code determine a first range,
wherein the device is configured for detecting the multibyte error if at least one of the following conditions is met:
(a) at least one error position signal does not lie in the first range,
(b) at least one error position signal indicates at least one error but fewer than τ errors in the first range and no 1-byte error to (τ−1)-byte error is present.

9. The device as claimed in claim 8, wherein the device is part of a memory or of a memory system or is embodied separately from the memory or the memory system.

10. The device as claimed in claim 8, wherein condition (a) furthermore comprises: the at least one error position signal which does not lie in the first range lies in a second range determined by bytes of a non-shortened error code which are not also bytes of the shortened error code.

11. The device as claimed in claim 8, wherein a number of the at least one error position signal is determined by counting.

12. The device as claimed in claim 8, wherein a byte of the code word is referenced by the error position signal.

13. The device as claimed in claim 8, wherein the at least one error position signal is determined by at least one locator polynomial of the shortened error code.

14. The device as claimed in claim 8, wherein the shortened error code is a Bose-Chaudhuri-Hocquenghem code of length n over a Galois field GF (2^{m}) where n<2^{m-}1 and m≥3 holds true.

15. The device as claimed in claim 8, wherein the shortened error code is a Reed-Solomon code over a Galois field GF (2^{m}).

16. A method for detecting a non-correctable multibyte error, comprising receiving a non-shortened error code including a plurality of codewords;
determining a shortened error code based on the non-shortened error code, the shortened error code having a shorter length and/or having shorter codewords than the non-shortened error code, but the shortened error code having the same number of check bits as the non-shortened error code such that the shortened error code and the non-shortened error code each represent a τ-byte error correcting code;
determining a first number of error position signals for bytes of a codeword in the shortened error code, wherein bytes of the codeword in the shortened error code correspond to a first range;
wherein the non-correctable multibyte error is detected if at least one of the following conditions is met:
(a) at least one of the first number of error position signals does not lie in the first range,
(b) at least one of the first number of error position signals indicates at least one error but fewer than terrors in the first range and there is no 1-byte error to (τ−1)-byte error present.

17. The method as claimed in claim 16, wherein a number of specific bytes of the codeword are identified by the first number of error position signals, respectively.

18. The method as claimed in claim 17, wherein the first number of error position signals are determined by at least one locator polynomial of the shortened error code.

19. The method as claimed in claim 18, wherein the shortened error code is a Bose-Chaudhuri-Hocquenghem code of length n over a Galois field GF (2^{m}) where n<2^{m}−1 and m≥3 holds true.

20. The method as claimed inclaim 18, wherein the shortened error code is a Reed-Solomon code over a Galois field GF (2^{m}).
